(19) United States
(12) Patent Application Publication
(10) Pub. No.: US 2015/0136401 A1
(43) Pub. Date: May 21, 2015

(54) SYSTEM AND METHOD FOR COLD CRACKING

(71) Applicant: INNOVATIVE CRUDE TECHNOLOGIES INC. D/B/A ICT, Millstone, NJ (US)

(72) Inventors: Ruediger Uwe Nuerk, Vienna (AT); Joseph M. Laura, Springfield, NJ (US)

(21) Appl. No.: 14/587,285

(22) Filed: Dec. 31, 2014

Related U.S. Application Data
(63) Continuation of application No. 13/220,280, filed on Aug. 29, 2011, now abandoned.

(51) Int. Cl. E21B 43/24; E21B 36/00; C09K 8/592

(52) U.S. Cl. CPC E21B 43/24; C09K 8/592; E21B 36/00
USPC 166/303; 166/302; 166/57

(57) ABSTRACT

Method to enhance the recovery of oil from an oil field, comprising: applying heat to a colloidal hydrocarbonic medium that comprises hydrocarbon chains; and applying pressure waves having a predetermined frequency and intensity to hydrocarbon chains, in order to crack hydrocarbon chains into relatively shorter hydrocarbon chains. Optionally: applying heat may comprise applying steam; the pressure waves may be applied directly or indirectly to hydrocarbon chains to be cracked; applying pressure waves may be performed within the oil field, by use of an Activator within or outside of the oil field; applying pressure waves may be performed within the oil field; applying pressure waves may be performed by use of a rotor situated in a housing pervaded by the colloidal hydrocarbonic medium.

### CROSS-REFERENCE TO RELATED APPLICATIONS

This application is a Continuation of U.S. patent application Ser. No. 13/220,280, filed on Aug. 29, 2011, the entire content of which is hereby incorporated by reference in its entirety.

### BACKGROUND

1. Field of the Invention

Embodiments of the present invention generally relate to a system and method for the treatment of a liquid having a hydrogen, oxygen bond in its composition, particularly liquids comprising a colloid hydrocarbonic medium, mineral oils or any ferromagnetic fluid, by use of a pressure wave emission mechanism operating at reduced temperatures.

2. Description of Related Art

Heavy crude oil or extra heavy crude oil is any type of crude oil which does not flow easily. It is referred to as “heavy” because its density or specific gravity is higher than that of light crude oil. Heavy crude oil has been defined as any liquid petroleum with an American Petroleum Institute (“API”) gravity less than 20°. Extra heavy oil is defined with API gravity below 10.0° API (i.e. with density greater than 1000 kg/m3 or, equivalently, a specific gravity greater than 1).

In contrast, light crude oil is liquid petroleum that has a low density and flows freely at room temperature. It has a low viscosity, low specific gravity and high API gravity due to the presence of a high proportion of light hydrocarbon fractions. It generally has a low wax content. Light crude oil receives a higher price than heavy crude oil on commodity markets because it produces a higher percentage of gasoline and diesel fuel when converted into products by an oil refinery.

Sweet crude oil is a type of petroleum that contains less than about 0.5% sulfur, compared to a higher level of sulfur in sour crude oil. Sweet crude oil contains small amounts of hydrogen sulfide and carbon dioxide. High quality, low sulfur crude oil is commonly used for processing into gasoline and is in high demand, particularly in the industrialized nations. “Light sweet crude oil” is the most sought-after version of crude oil as it contains a disproportionately large amount of these fractions that are used to process gasoline (naphtha), kerosene, and high-quality diesel fuel.

The amount or volume of light crude products directly present in crude oil worldwide is not sufficient to cover the worldwide consumption of various fuels. Therefore, technologies referred to as “cracking” have been developed and are necessary to maximize the light product yield from crude oil. Cracking is the process whereby complex organic molecules (heavy hydrocarbons) are broken down into shorter molecules (light hydrocarbons), predominantly by the breaking of carbon-carbon bonds by the use of precursors.

Conventional cracking processes used in refineries can be separated into two groups of cracking mechanism: thermal cracking and catalytic cracking. Both kinds of processes were optimized over the years to yield short hydrocarbons of a relatively narrow chain length range, which are suitable to produce liquid fuels (e.g., gasoline, diesel, kerosene, etc.).

Shortfalls of conventional cracking processes include a relatively low yield of hydrocarbons having a short chain length, and a relatively high combination of temperature and pressure needed to realize the process at a commercially feasible rate.

Thus, there is a need for a cracking process that is able to produce relatively higher yields of hydrocarbons having a short chain length, and at a relatively lower combination of temperature and pressure in order to realize the process at a commercially feasible rate.

### SUMMARY

Embodiments of the present invention generally relate to a procedure for treatment of liquids, in particular a colloid hydrocarbonic medium mineral oils, in order to the increase the content of light, low-boiling range fractions comprises a subjecting a processed liquid to pressure waves of a first frequency, and forwarding the liquid to a tank or to a pressure wave emission mechanism for further conventional oil processing.

In accordance with certain embodiments, it has been discovered that with a suitable exposure of crude oils and/or other mineral oils to pressure waves with certain favorable frequencies, the liquids show an improved distillation profile, which shows increased increments of short chain, low boiling range fractions. As a result, the yield of high-quality light products derived from crude oils and mineral oils is increased during a refining process. Generally, the resonance excitation within the liquid, occurring due to the oscillation energy with suitable choice of the oscillation frequency, is responsible for the strand breaks or cracking mentioned. The process further comprises injection of steam into the liquid, in order to increase the temperature of the liquid and/or the pressure upon the liquid, in order to increase the rate of reaction of a chemical process.

In a further embodiment, the pressure wave emission mechanism is implemented in form of a rotor situated in a housing pervaded by the liquid subject to treatment.

Embodiments in accordance with the present invention provide a method to enhance the recovery of oil from an oil field, comprising: applying heat to a colloidal hydrocarbonic medium that comprises hydrocarbon chains; and applying pressure waves having a predetermined frequency and intensity to hydrocarbon chains, in order to crack hydrocarbon chains into relatively shorter hydrocarbon chains.

The step of applying heat may comprise applying steam; the pressure waves may be applied directly to hydrocarbon chains to be cracked; the pressure waves may be applied indirectly to hydrocarbon chains to be cracked; the step of applying pressure waves may be performed within the oil field, by use of an Activator within the oil field; the step of applying pressure waves may be performed within the oil field, by use of an Activator outside of the oil field; the step of applying pressure waves may be performed within the oil field; and the step of applying pressure waves may be performed by use of a rotor situated in a housing pervaded by the colloidal hydrocarbonic medium. Structure and operation of the Activator are described below in greater detail.

The step of applying pressure waves may comprise: applying pressure waves to a first plurality of hydrocarbon chains, in order to produce an activated colloidal hydrocarbonic medium; and introducing the activated colloidal hydrocarbonic medium to a second plurality of hydrocarbon chains in order to produce a radical chain reaction.

Embodiments in accordance with the present invention provide a system to enhance the recovery of oil from an oil field, the system may comprise: a heat applicator configured to apply heat to a colloidal hydrocarbonic medium that comprises hydrocarbon chains; and a pressure wave generator configured to apply pressure waves having a predetermined frequency and intensity to hydrocarbon chains, in order to crack hydrocarbon chains into relatively shorter hydrocarbon chains.

The heat applicator may comprise a steam injector.

The pressure wave generator may be: configured to apply pressure waves directly to hydrocarbon chains to be cracked; or configured to apply pressure waves indirectly to hydrocarbon chains to be cracked.

Wherein the pressure wave generator may be configured to apply pressure waves to a first plurality of hydrocarbon chains in order to produce an activated colloidal hydrocarbonic medium, the system may further comprise: an interface from the pressure wave generator to a second plurality of hydrocarbon chains in order to produce a radical chain reaction by introducing the activated colloidal hydrocarbonic medium to the second plurality of hydrocarbon chains.

The pressure wave generator: may comprise an Activator within the oil field, the Activator being configured to apply pressure waves within the oil field; may comprise an Activator outside of the oil field, the Activator being configured to apply pressure waves outside of the oil field; and may comprise a rotor situated in a housing pervaded by the colloidal hydrocarbonic medium.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments of embodiments encompassed within the scope of the present invention, and, therefore, are not to be considered limiting, for the present invention may admit to other equally effective embodiments, wherein:

FIG. 1 depicts chemical reaction energy in accordance with an embodiment of the invention;

FIG. 2 illustrates two functions of particle energy distribution in accordance with an embodiment of the invention;

FIG. 3 illustrates a method for enhancing the recovery of oil from an oil field in accordance with an embodiment of the invention;

FIG. 4 illustrates another method for enhancing the recovery of oil from an oil field in accordance with an embodiment of the invention; and

FIG. 5 depicts a liquid activator system in accordance with one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a procedure for the treatment of a liquid, in particular a colloid hydrocarbonic medium, mineral oil or the like, in order to increase the content of light fractions having a lower boiling point.

Embodiments in accordance with the present invention provide a method and system designed to destabilize, weaken, shear or even crack up molecular bonds in liquids, for example, a colloid hydrocarbonic medium, mineral oils or related substances, in order to thus receive, in the course of the subsequent refining process, an increased portion of short chains and low-boiling point fractions. Weakening or destabilizing the molecular bonds may mean, for instance, that the molecular bonds enter an unstable energy state, i.e., a state higher than the minimum energy. At such a higher energy state, the molecular bonds are susceptible to breaking upon addition of a lesser amount of energy compared to molecular bonds not at the higher energy state. For this purpose, energy is supplied to the liquid from two sources. First, a mechanical oscillation energy in the form of pressure waves is introduced into the liquid. Second, thermal energy in the form of steam is supplied to the liquid. Together, the energy from these two sources leads to a destruction of the chemical connections, and to the strand break of long chains, high-boiling molecule fractions.

In accordance with certain embodiments, it has been discovered that with a suitable exposure of crude oils and/or other mineral oils to pressure waves with certain favorable frequencies, at a predetermined minimum temperature and/or pressure conditions, the liquids show an improved distillation profile, which shows increased increments of short chain, low boiling range fractions. As a result, the yield of high-quality light products derived from crude oils and mineral oils is increased during a conventional refining process. Generally, it is the resonance excitation within the liquid, occurring due to the oscillation energy with suitable choice of the oscillation frequency, that is responsible for transforming the liquid by breaking or cracking of molecular chains. The minimum heat and/or pressure conditions allows for the transformation of the liquid to initiate, or to occur at a faster rate, or to transform a greater fraction of the liquid.

The minimum temperature and/or pressure conditions may be provided by the natural environment, for instance by forces that exist naturally within a deep oil well. However, if the natural environment does not provide adequate temperature and/or pressure conditions, heat and/or pressure may be provided by an external source, e.g., by the injection of steam into the oil well.

Provided below is a description at a chemical and quantum-mechanical level of a process in accordance with an embodiment of the invention.

In quantum-mechanical analysis, a predetermined volume of hydrocarbon feedstock (e.g., crude oil, fuel oil, etc.) may be analyzed as a quantum-mechanical system that behaves as a single molecule having molecular bonds that are tightened by strong covalent bonds. In this analysis, the quantum-mechanical system is not describable using exact chemical formulas, nor by constants like melting and boiling points, dielectric permittivity, dipole moment, loss angle, electrical conduction, heat content (enthalpy) ΔH°, ΔS, and so forth.

If this quantum-mechanical system is excited by imparting an intensive energy in substantially any form, then the quantum-mechanical system becomes unstable, and various processes will occur like destruction, breakage and re-forming/redistribution of molecular bonds, division of the quantum-mechanical system into low-molecular and high-molecular compounds. Characterizing the resulting compounds as linear, cyclic, aromatic etc., is not meaningful because, under the quantum analysis, it is the state of the quantum-mechanical system under conditions of force fields of the environment that is meaningful, rather than the compositions of the various compounds within the quantum-mechanical system.

Crude oil or fuel oil is not a physical mixture, and the processing of it is not a physical process of reforming, remixing, and the like. Rather, processing of crude oil or fuel oil is a chemical reaction which can be represented by Equation (1):

Primary hydrocarbon liquid=Light fractions+Heavy residue+ΔH (1)

where ΔH is a change of the heat content in the system (i.e., an enthalpy or a reaction energy). A positive change in heat content may be released as thermal energy and/or other forms of energy (e.g., photons). A negative change in heat content is accounted for by an infusion of an external source of energy.

During oil processing or refining, a chemical reaction flows in the direction of energy consumption, in contrast to combustion, in which the chemical reaction flows in the direction of heat release.

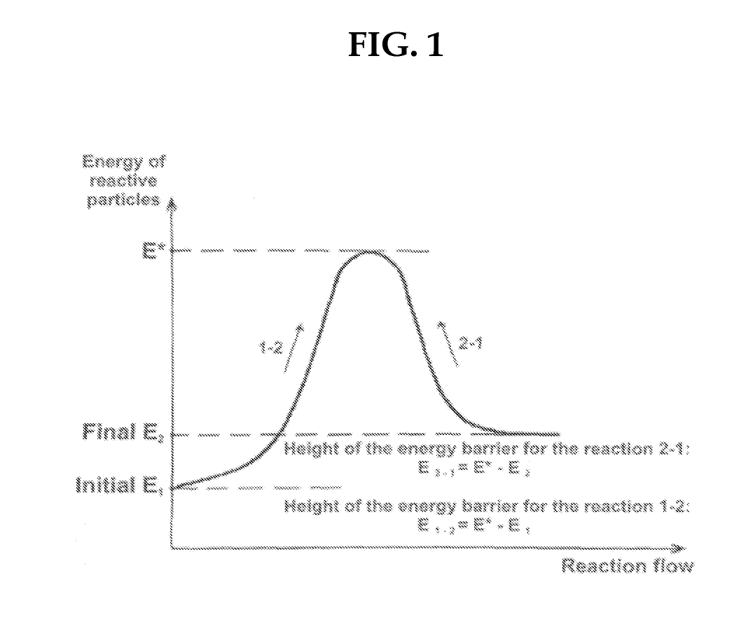

Atoms of the chemical elements in oil (e.g., fuel oil) have positive nuclei charges and negative electron envelope charges. When reactive atoms approach or collide with each other, an energy barrier arises as shown in FIG. 1. The energy barrier, also known as an activation energy (“E*”), is an energy that must be overcome in order for a chemical reaction to occur. Only particles that are more energetic than the activation energy can react, and particles that are less energetic than E* will scatter without reacting.

FIG. 1 illustrates chemical reaction energy during phases of a chemical reaction. The Y-axis represents an energy state, and the X-axis represents a chemical state. E₁ represents an energy state for particles at a first chemical state (“state 1”). E₂ represents the energy state for particles at a second chemical state (“state 2”). E*, as described earlier, is the activation energy. For a chemical process to proceed from state 1 to state 2 (i.e., left-to-right along FIG. 1), an initial energy in the amount of (E*−E₁) must be supplied in order to produce state 2. A net amount of energy of (E₂−E₁) is consumed. For a chemical process to proceed from state 2 to state 1 (i.e., right-to-left along FIG. 1), an initial energy in the amount of (E*−E₂) must be supplied in order to produce state 1. A net amount of energy of (E₂−E₁) is produced.

In the context of chemical reactions in oil (e.g., fuel oil), the energy (E₂−E₁) in FIG. 1 is the net input energy needed for a chemical reaction from state 1 to state 2 in order to obtain light fractions. The energy (E*−E₁) must be supplied to activate the reaction from state 1 to state 2, and the energy (E*−E₂) is recovered when the reaction is completed.

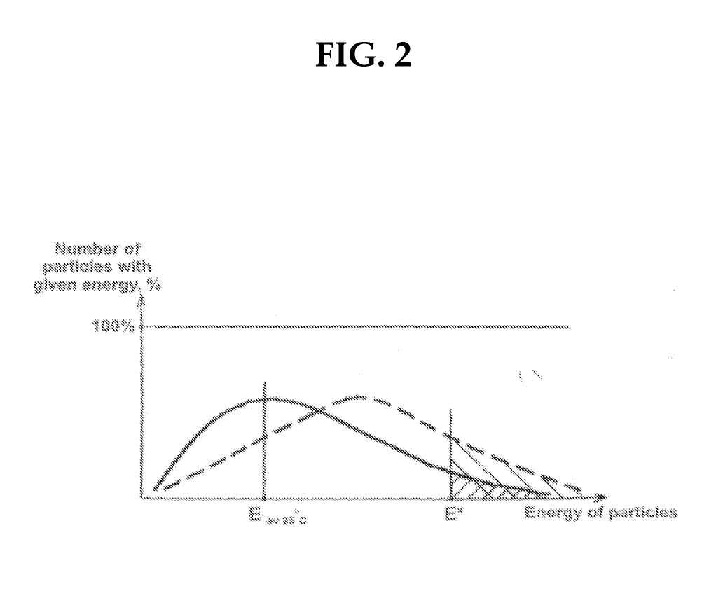

FIG. 2 illustrates a particle-energy distribution function. The X-axis represents the energy of individual particles, and the Y-axis represents an energy distribution function of the particles. As can be seen from FIG. 2, particle energies for individual particles may extremely differ. For example, if an ambient temperature in a room is 25° C., then the energy distribution function has an average value (“Eₐᵥ”) of 25° C., but there are also particles with the energies corresponding to −100° C. or −200° C. (a smaller percentage), as well as +100° C., +200° C. . . . +1000° C. (the descending right side of the curve).

The magnitude of the activation energy E*, shown in FIG. 1 as a horizontal line at y=E*, is shown in FIG. 2 as the vertical line x=E*. Only particles with energy contents of E* or higher can react, corresponding to the shaded areas to the right of E* in the curves of FIG. 2. If, throughout the volume of the reagent, the reagent does not have an average energy above E*, then the reaction should not be considered completely impossible. Rather, the reaction may take place for extremely energetic molecules corresponding to particles in the shaded area of the curve “tail”, but at very slow rate (for example, oxidation below flash temperature). As the particles belonging to the shaded area start to react, new ones will come to take their place due to the energy redistribution, but this process requires time. The rate of this redistribution governs the reaction rate.

It is important to keep in mind that all the reactions are recoverable, i.e., if there are the particles with energy E* (or higher), which can overcome the energy barrier from left to right, then the reaction product will also contain the particles with the energy sufficient to reach the highest point of the barrier from right to left (especially because relatively less energy is required in this direction and the barrier is more easily overcome). However, at the beginning the number of such particles is small, but as the reaction products accumulate, a mobile balance (equilibrium) can occur, i.e., the number of nascent particles of the light fraction can equal the number of those which revert to the initial state (simply speaking, the light fractions dissolve again or recombine), the product yield will no longer increase.

The influence of various factors upon the process flow is taken into account by the principle of mobile equilibrium (Le Chateliér principle): if there is an impact on a system which is in equilibrium, then some processes should occur within this system to countervail this impact. So, if water and steam (in equilibrium) in a closed vessel are compressed, then a part of the steam will condense to water and further compression will be impossible; if it is heated, then a part of the water will evaporate spending latent heat, and no temperature increase will occur. For the systems in equilibrium the Le Chateliér principle allows the direction of the reaction to be influenced. For example, if the reaction described by Equation (1) requires an energy input (e.g., thermal absorption), then heating the reagents would be effective to increase the product yield. If the reaction described by Equation (1) produces a gaseous product, then application of a vacuum would shift the reaction to the right of FIG. 1, since the vacuum will facilitate the equilibrium without lowering the height of the energy barrier—it will not facilitate the regrouping or transformation and the breakage of bonds. Likewise, for a reaction described by Equation (1), specifically one that produces light fractions, removal of light fractions from the reaction zone will increase the product yield by shifting the reaction to the right along the curve of FIG. 1.

Thus, it is both economically and technically advisable to avoid the mobile equilibrium, not to “squeeze out” the maximum possible yield in excess of some optimum; it is much better to remove the light products and continue processing of the residue, as is in the industry.

The reaction rate may be expressed by an Arrhenius equation as shown in Equation (2).

$$k = A {e}^{- \frac{{E}^{*}}{RT}} \qquad ( 2 )$$

Equation (2) shows that the lower the barrier E* is, the higher the reaction rate k will be. This relationship is used in catalysis and cracking. Catalysts cannot supply energy to the reagents, but some intermediate reactions involving the catalysts with the reagents will occur, and these intermediate reactions flow at a lower activation energy than E*. Upon completion of the intermediate reaction, the catalysts are released and are available for further catalytic reactions with the initial reagents.

It is also seen from Equation (2) that the reaction rate k will increase as the temperature T rises. FIG. 2 shows that as the temperature rises, the curve will shift to the right as shown by the dotted line in FIG. 2. Therefore the shaded area under the curve will increase and thus the number of the particles with energy E* or higher, sufficient to overcome the barrier, will increase as well.

Let us return to the characterization of a predetermined volume of hydrocarbon liquid (oil, fuel oil) as a single quantum-mechanical system in the form of a giant molecule which is tightened by strong covalent bonds. In order to excite it for the proper transformation and the breakage of internal bonds, i.e., to run the chemical reaction, the required energy (i.e., activation energy) is imparted by use of increasingly higher temperature of the process, i.e., thermal energy is used.

Thermal energy may be considered a low-quality energy. All types of energies are convertible in strictly equivalent proportions, but only conversion of heat to other forms of energy is “taxed”, i.e., a part of thermal energy is dispersed in ambient space in vain.

Thus, in order to run the reaction with the shift of equilibrium to the right and attain even more yield of the light fractions, a machine may be used to transform kinetic energy of the Activator to high quality activation energy. Theoretically this transformation should be equivalent, totally, but in practice heating due to mechanical friction and coefficient of internal friction (viscosity) of liquid is unavoidable.

Thermal energy can propagate by way of direct contact (e.g., heat transfer or transmission); convection; and/or emission (i.e., radiation). The first two are chaotic, but radiation—especially at high temperatures—is a quantized energy of a higher quality.

The fact that all types of energies can transform to each other in equivalent proportions, does not mean that all of them (except heat energy) have the same quality. For example, a laser beam is a rather high-quality energy because it has coherence; it can focus well; and it emits high-power energy. In contrast, the electric power, which feeds the laser, is energy of a relatively lower quality.

An Activator in accordance with embodiments of the present invention is a device for which kinetic energy of a macro-ordered solid body is dynamically transformed to a higher-quality energy.

An Activator produces resonance energy in a colloid hydrocarbonic liquid, with specific frequencies per bond, which impacts the molecular orbital (“MO”) level of the incited bond within the processed liquid. In one embodiment in accordance with the present invention, the Activator includes a wheel with lamellae, the wheel being driven by a motor (e.g., an electric motor). The wheel is enclosed in a reaction chamber. Inside the reaction chamber, the wheel is immersed in a liquid, for example, a colloid hydrocarbonic medium, mineral oils or related substances. The wheel is shaped such that as it spins it produces resonance energy in the liquid, with specific frequencies per bond, which impacts the MO level of the incited bond within the processed liquid. The relation between the radius of the wheel, the geometry of the reaction chamber, the produced resonance energy and its frequency with the structure of specific bond can be applied in practice to specifically activate the individual C—H, C—C and C—S bonds. Embodiments in accordance with the present invention have been developed to incite or co-incite these bonds.

In a working zone of the Activator, local ionization of certain chemical bonds of oil occurs, when some of the electrons, which are responsible for oil balance, leave their orbits and pass for a short time to considerably higher orbits, i.e., local ionization of crude oil or fuel oil takes place. The ionization is a change in electron states of molecules of the crude oil caused by the Activator. If the electrons were to return to their former lower-energy states, energy would be released. However, after leaving the Activator, this oil cannot transform to its former energy state because of generation of numerous new radicals. But, if this ionized oil is introduced to un-ionized oil, a radical chain reaction may occur, such that a self-sustained cracking of hydrocarbon bonds may be induced.

Mass breakage, destruction and disintegration of chemical bonds occur during crude oil or fuel oil processing in the Activator. Referring to the model of a single quantum-mechanical system or a giant molecule, the reaction in the Activator involves a mechano-chemical transformation of the crude oil or fuel oil to a polydisperse mass of small groups with broken unsaturated valence bonds. A polydisperse mixture of highly active and rapid radicals is generated. The structure and composition during the transition process is relatively unimportant, but rather their state.

The distribution functions of energies, compositions, masses, and activities of the radicals are the same in qualitative respect like in FIG. 2. A part of the radicals will remain nearly unchanged as heavy residue at the end of the process. Another part, the highest percentage, will transform to medium-active radicals, which should redistribute and form the entire spectrum of the light fractions. A small percentage of most active short-lived radicals will release excess energy and replenish the group of medium-active radicals. Hence, in the crude oil or fuel oil passed through the Activator, internal bonds are regrouped and have a new energy state, which is higher in value than E₁ in FIG. 1.

Application to Cracking of Crude Oil

The pressure waves discussed above may be generated by a pressure wave emission mechanism, which may be implemented in form of a source of mechanical oscillations such as a rotor. The rotor may be situated in a housing pervaded by a liquid subject to treatment. In one embodiment, liquid enters a cavity of a rotating embedded construction unit. The liquid flows radially outwards, through the radial openings in the rotor into an annular gap, whereby the radial openings are evenly arranged at the exterior surface of the rotor. The liquid in the annular gap is subjected to the fast rotation of the rotor as function of: (a) the rate of revolution, (b) the rotor radius and (c) the number of openings at the exterior surface of the rotor, with an appropriate frequency of oscillating and reciprocating pressure waves. Accordingly, substantial amounts of energy are directed into the liquid, destabilizing the chemical bonds and/or breaking them apart.

Specific resonance frequencies influence a molecular structure of hydrocarbon materials, in particular physical properties and reaction behavior of hydrogen, carbon and sulfur, in order to facilitate cracking long hydrocarbon chains with less energy input, and to facilitate a stable recombination of light additives like gas condensate or natural gas with the heavy oil.

Embodiments in accordance with the present invention may perform a “cold cracking,” meaning that a significantly lower reaction temperature is used during the cracking process, and therefore lower thermal energy input is required compared to conventional refinery processes. Cold cracking is ordinarily performed without the need for a precursor. An “Activator,” as used herein unless clearly indicated otherwise, refers to an apparatus that incorporates the cold cracking process.

A cold cracking Activator includes a pressure wave emission mechanism using high performance oil pumps. The cold cracking Activator and associated piping is brought into a highly critical resonance mode that affects hydrogen and carbon compounds at a quantum level, to produce a desired cracking and reforming of hydrogen and carbon compounds for crude upgrading, i.e., increasing the proportion of light hydrocarbons in the crude oil.

Activation of hydrogen destabilizes C—H bonds in crude oil to produce treated oil, resulting in a relative increase in the cracking reaction process at lower temperature ranges. Subsequent heating of the treated oil causes an effect similar to hydro-cracking, thus increasing the proportion of low boiling range light products and unsaturated hydrocarbon compounds, and decreasing viscosity of the treated oil. The unsaturated hydrocarbon compounds may need further treatment and saturation with hydrogen.

Carbon activation cracks up C—C single and double bonds. A process using a cold cracking carbon Activator can be designed to promote absorption of lighter hydrocarbon products like light crude oil, nafta, gas oil or gas condensate into heavy oil, to produce a light synthetic crude oil with a low proportion of unsaturated hydrocarbons.

A system as so described may operate as a cracker at relatively low temperatures. Hydrogen saturation occurs by an addition of short hydrocarbons like natural gas or gas condensate, by use of a hydrotreater as discussed later in greater detail.

Cold Cracking

Embodiments in accordance with the present invention are able to perform the cracking of crude oil under low temperature and without a catalyst. The following working principle was deducted from various process descriptions and analyses of test runs.

In embodiments in accordance with the present invention, energy from a mechanically introduced wave is used to dislocate an electron into an antibinding MO and then break the bond. The principle radical mechanism, which is initiated by introduction of the mechanically induced wave is the same as with thermal cracking.

An Activator apparatus produces resonance energy in the liquid, with specific frequencies per bond, which impacts the MO level of the incited bond within the processed liquid. In one embodiment in accordance with the present invention, the Activator includes a wheel with lamellae, the wheel being driven by a motor (e.g., an electric motor). The wheel is enclosed in a reaction chamber. Inside the reaction chamber, the wheel is immersed in a liquid, for example, a colloid hydrocarbonic medium, mineral oils or related substances. The wheel is shaped such that as it spins it produces resonance energy in the liquid, with specific frequencies per bond, which impacts the MO level of the incited bond within the processed liquid. The relation between the radius of the wheel, the geometry of the reaction chamber, the produced resonance energy and its frequency with the structure of specific bond can be applied in practice to specifically activate the individual C—H, C—C and C—S bonds. Embodiments in accordance with the present invention have been developed to incite or co-incite these bonds.

When breaking the C—H bond for creating radicals, an isomerization can also take place. Breaking the C—C bond causes the normal cracking with a shortening of the molecules and therefore direct production of light crude products, i.e., low boiling hydrocarbons in the typical fuel range.

Therefore, based on the theoretical approach, a hydrogen Activator designed to activate C—H bonds would lead more to the formation of isomerized products, still improving the pour point and boiling point of heavy crude oils. A carbon Activator designed to activate C—C bonds would break long-chained molecules, and hence provide production of low boiling products, typically in the liquid fuel range.

Indirect Activation

In order to ensure a stable and safe operation of the process, it has to be verified that the induced mechanical wave is substantially confined within the reaction chamber, and that the chain reaction based on the radical chain cracking reaction can safely be stopped within the Activator. If the mechanical wave is not substantially entirely contained within the reaction chamber, there could be an effect on oil outside the reaction chamber.

Confinement of activation energy to within the Activator to promote direct activation is useful for downstream processing, i.e., processing that takes place after crude oil is extracted from an oil well. However inside the oil well, activation outside the reaction chamber may be desirable. Vibrations, oscillations, mechanical perturbations, and quantum effects that had been confined within the reaction chamber are able to propagate outside the reaction chamber into the surrounding crude oil. Activation that occurs outside the reaction chamber in this way is a remote activation, and remote activation is an embodiment of indirect activation.

Another embodiment of indirect activation in accordance with the present invention relates to a potential activation of fresh crude oil caused by mixing it with the “activated” oil. This process may also be referred to herein as stimulation, or stimulating the oil well. Stimulation is accomplished by use of an Activator. The Activator may be located inside the well. The Activator may also be located outside the oil well, with the activated oil being pumped back down into the well. Stimulation weakens, destabilizes, shears or breaks the hydrogen-hydrogen bonds in the crude oil.

Stimulation and the resulting chemical reactions can be explained by use of radical chain theory for self-sustaining chemical reactions. If an activation reaction does not stop substantially immediately in activated oil upon its exit from the Activator reactor, the activation reaction may continue in fresh crude oil outside the Activator reactor, as long as the energy (or the temperature) is high enough. Activated oil has a property such that it is capable of initiating a radical chain reaction when the activated oil comes in contact with unactivated oil.

The activation reaction may be initiated if the fresh crude oil is heated up to between approximately 40 degrees Celsius and approximately 90 degrees Celsius. As the pressure increases, the temperature used for activation decreases. Conversely, if the pressure decreases, the temperature used for activation increases. In contrast, conventional thermal cracking requires a temperature of about 360 degrees Celsius to about 1000 degrees Celsius. The resulting cracking will tend to increase the volume of the treated oil, a gaseous product is created, and the cracking may become self-sustaining. A highly activated material is created, which is returned to the oil well at a minimum temperature of approximately 60 degrees Celsius.

Activated crude oil can also be used to improve other extraction technologies such as a steam injection process. The steam injection process uses temperature and pressure to enhance recovery of crude oil. Augmenting the steam injection process by introducing activated crude oil into the oil well will provide more production by accelerating the recovery of crude oil (i.e., a production rate) and/or by extracting a greater portion of the crude oil from the well. The augmented steam injection process provides a lower cost process, lessens the need for outside energy by reusing energy, and increases production rates.

In the oil well the highly active material comes into contact with the untreated heavy crude which is in the well. Through this contact a direct activation is initiated by way of a radical chain reaction. This radical chain reaction can activate a much larger volume of heavy crude oil than the initial volume of activated material, such as 10 times, 100 times or even the whole oil reservoir. This radical chain reaction will create the gaseous byproduct as part of the cracking. The gaseous byproduct creates pressure in the oil well, which helps extract the oil. The cracking will further act to reduce the viscosity of the crude oil to be extracted. An oil well may be stimulated frequently or even continuously in order to maintain constant production, or an increase of production, out of the oil well.

This hydrogen activation process, and stimulation in particular, may be followed by a carbon activation process. Carbon activation, when following hydrogen activation, may be able to increase the light fraction of the crude oil from about 10% to 25% to about 40% to 60%, with an API of about 30 to 35. The treated oil will be easier to extract from the well, and may be extracted by lesser use (or no use at all) of steam or chemicals, which are environmentally damaging methods of extraction. When extracted from the well, the resulting crude oil may be subject to dewatering and additional downstream refining steps.

According to theory, a reaction mechanism in cold cracking technology may be a radical mechanism, initiated by an input supply of the required energy in order to break the first bonds. The radicals produced by this mechanism induce a chain reaction which becomes the basis for the oil conversion in the reactor.

Embodiments in accordance with the present invention provide a method to enhance the recovery of oil from an oil field, and in particular the recovery of light products from heavy crude oil. The method may include usage of an Activator to cold-crack molecular chains of heavy crude oil, to produce hydrocarbons having shorter molecular chains. The cold cracking may be by way of either a direct activation process or an indirect activation process.

The indirect activation process may include a radical chain reaction process, such that an activated liquid such as an activated crude oil is introduced into raw crude oil. An activated crude oil is one in which the targeted molecular bonds have been unsaturated and are weakened, sheared, or cracked. The activated crude may initially be created or obtained by use of an activation device, either direct activation or indirect activation. The operating principles of direct and indirect activation have been described above. When the activated crude oil comes into contact with unactivated crude oil, a self-sustaining radical chain reaction occurs in which the activated crude oil acts as a catalyst to crack the unactivated crude oil, thereby creating additional amounts of activated crude oil. The rate of reaction depends upon the temperature and pressure conditions inside the well. The process is effective for substantially any crude oil. The radical chain process may include simply introducing activated oil into unactivated oil, and then waiting.

The method may also include a steam injection process used to stimulate the crude oil in order to increase the rate of reaction of the activation process. The activation process consumes energy in order to crack long hydrocarbon chains into shorter hydrocarbon chains. Application of external energy in the form of heat and/or pressure will accelerate the cracking process. Steam injection provides the external energy, by the heat of the steam and the increase in pressure from the injection of the steam.

Methods in accordance with embodiments of the invention may be performed in whole or in part within an oil well or oil field, or within a chamber outside of but coupled to the oil well or oil field (e.g., for reinjection of activated oil).

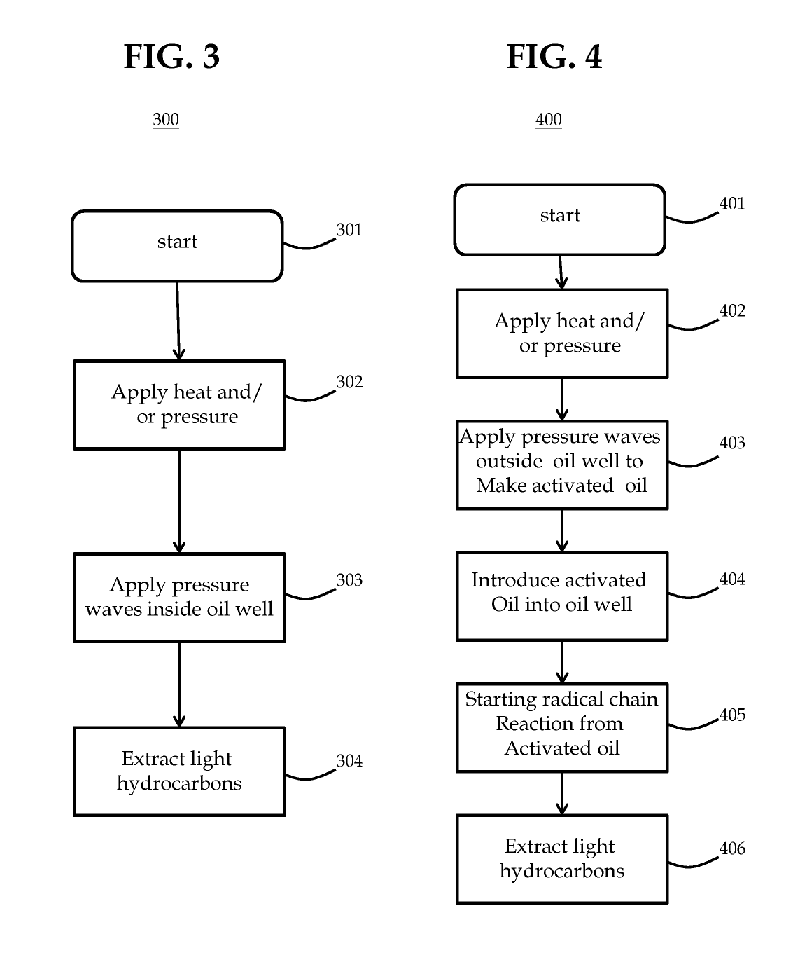

FIG. 3 illustrates a method 300 for enhancing the recovery of oil from an oil field in accordance with an embodiment of the invention. Method 300 begins at starting step 301. Heat and/or pressure are applied at step 302. Pressure waves are applied inside the oil well at step 303. Steps 302 and 303 may be applied in any order and may be applied repeatedly. The heat, pressure, and/or pressure waves crack the long hydrocarbon chains to produce light hydrocarbons. At step 304, the light hydrocarbons are extracted from the oil well.

FIG. 4 illustrates a method 400 for enhancing the recovery of oil from an oil field in accordance with another embodiment of the invention. Method 400 begins at starting step 401. Heat and/or pressure are applied at step 402. Pressure waves are applied outside the oil well, at step 403, in order to make activated oil. Steps 402 and 403 may be applied in any order and may be applied repeatedly. At step 404, the activated oil is introduced into the oil well. At step 405, the activated oil starts a radical chain reaction inside the oil well. The heat, pressure, and/or pressure waves crack the long hydrocarbon chains to produce light hydrocarbons. At step 406, the light hydrocarbons are extracted from the oil well.

Embodiments in accordance with the present invention may further provide a system to enhance the recovery of crude oil from an oil field, and in particular the recovery of light products from heavy crude oil. The system may include an Activator apparatus to cold-crack molecular chains of heavy crude oil, to produce hydrocarbons having shorter molecular chains. The cold cracking may be by way of either a direct activation process or an indirect activation process.

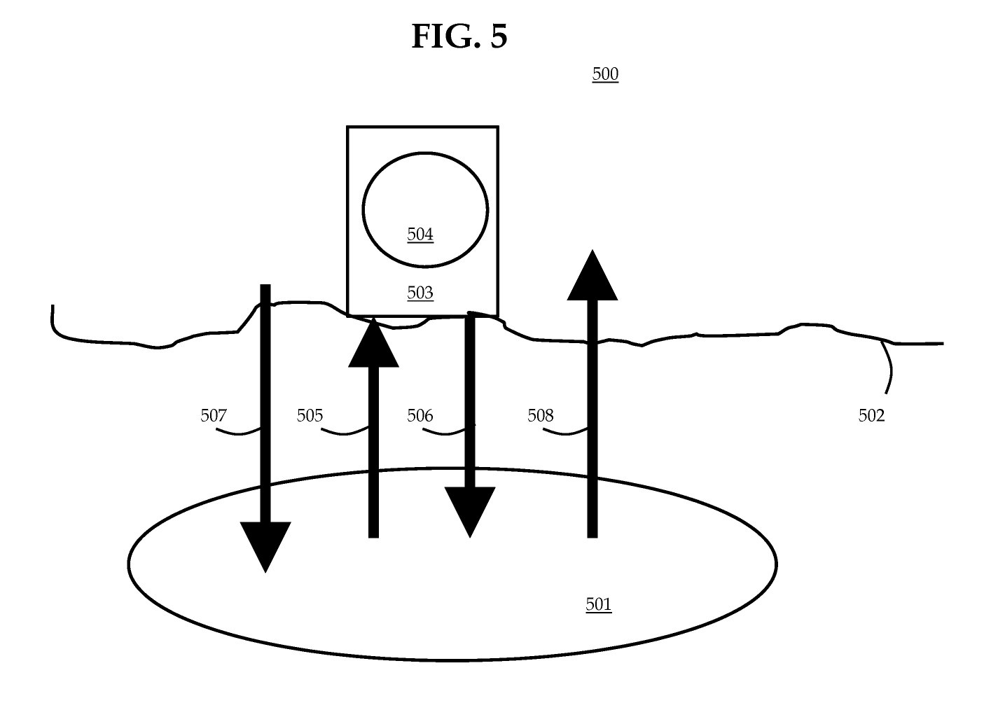

Referring now to FIG. 5, there is illustrated a system 500 to enhance the recovery of crude oil from an oil field 501, and in particular the recovery of light products from heavy crude oil, in accordance with an embodiment of the present invention. System 500 includes an Activator 503 that may be located above ground 502 (as shown in FIG. 5) or the Activator 503 may be located below ground 502 (not illustrated in FIG. 5). Activator 503 draws crude oil from oil field 501 via interface 505. The crude oil drawn via interface 505 is exposed to pressure waves generated by rotor 504 in order to produce activated oil. The activated oil may be introduced back into oil field 501 via interface 506. Heat and/or pressure may be introduced into oil field 501 via interface 507, for example by way of steam produced by a steam injector (not shown in FIG. 5). Activated oil produced introduced into oil field 501 may create a radical chain reaction inside oil field 501, thereby increasing the fraction of light hydrocarbons that are available for extraction. The crude oil (including increased fraction of light hydrocarbons) is then extracted from oil field 501 via interface 508 and transferred to downstream equipment (not shown in FIG. 5) for further refining and processing.

The Activator apparatus may be designed to destabilize, weaken, shear or even crack up molecular bonds in liquids, for example, crude oil, mineral oils or related substances, in order to produce an increased portion of short chains and low-boiling point fractions. For this purpose, mechanical oscillation energy is brought in the form of pressure waves into the liquid, leading to a destruction of the chemical connections, and to the strand break of long chains, high-boiling molecule fractions. The mechanical oscillation energy may be produced at a frequency that is designed to destabilize, weaken, shear or crack up a specific type of molecular bond, such as a dihydrogen (H—H) bond, or a carbon-hydrogen bond (C—H), or a sulfur bond with either hydrogen or carbon.

The system may also include a steam injector used to stimulate the crude oil in order to increase the rate of reaction of the activation process. The activation process consumes energy in order to crack long hydrocarbon chains into shorter hydrocarbon chains. The steam injector applies external energy in the form of heat and/or pressure to accelerate the cracking process. The steam injector provides the external energy, by the heat of the steam produced by the steam injector and by the increase in pressure from the injection of the steam.

The mechanical oscillation energy may be produced by a rotor situated in a housing pervaded by crude oil subject to treatment. The housing with rotor forms a reaction chamber. In one embodiment, crude oil enters a cavity of a rotating embedded construction unit. The crude oil flows radially outwards, through the radial openings in the rotor into an annular gap, whereby the radial openings are evenly arranged at the exterior surface of the rotor. The liquid in the annular gap is subjected to the fast rotation of the rotor as function of: (a) the rate of revolution, (b) the rotor radius and (c) the number of openings at the exterior surface of the rotor, with an appropriate frequency of oscillating and reciprocating pressure waves. The frequency of the oscillating and reciprocating pressure waves can be controlled by design of the revolution rate, the rotor radius, and the number of openings.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A method to enhance the recovery of oil from an oil field, comprising:
applying heat to a colloidal hydrocarbonic medium that comprises hydrocarbon chains;
applying pressure waves having a predetermined frequency and intensity to hydrocarbon chains; and
cracking hydrocarbon chains into relatively shorter hydrocarbon chains by application of the pressure waves.

2. The method of claim 1, wherein applying heat comprises applying steam.

3. The method of claim 1, wherein the pressure waves are applied directly to hydrocarbon chains to be cracked.

4. The method of claim 1, wherein the pressure waves are applied indirectly to hydrocarbon chains to be cracked.

5. The method of claim 1, wherein applying pressure waves comprises
applying pressure waves to a first plurality of hydrocarbon chains, in order to produce an activated colloidal hydrocarbonic medium; and
introducing the activated colloidal hydrocarbonic medium to a second plurality of hydrocarbon chains in order to produce a radical chain reaction.

6. The method of claim 1, wherein applying pressure waves is performed within the oil field, by use of an Activator within the oil field.

7. The method of claim 1, wherein applying pressure waves is performed outside of the oil field, by use of an Activator outside of the oil field.

8. The method of claim 1, wherein applying pressure waves is performed by use of a rotor situated in a housing pervaded by the colloidal hydrocarbonic medium.

9. A system to enhance the recovery of oil from an oil field, comprising:
a heat applicator configured to apply heat to a colloidal hydrocarbonic medium that comprises hydrocarbon chains; and
a pressure wave generator configured to apply pressure waves having a predetermined frequency and intensity to hydrocarbon chains, in order to crack hydrocarbon chains into relatively shorter hydrocarbon chains.

10. The system of claim 9, wherein the heat applicator comprises a steam injector.

11. The system of claim 9, wherein the pressure wave generator is configured to apply pressure waves directly to hydrocarbon chains to be cracked.

12. The system of claim 9, wherein the pressure wave generator is configured to apply pressure waves indirectly to hydrocarbon chains to be cracked.

13. The system of claim 9, wherein the pressure wave generator configured to apply pressure waves to a first plurality of hydrocarbon chains, in order to produce an activated colloidal hydrocarbonic medium, the system further comprises:
an interface from the pressure wave generator to a second plurality of hydrocarbon chains in order to produce a radical chain reaction by introducing the activated colloidal hydrocarbonic medium to the second plurality of hydrocarbon chains.

14. The system of claim 9, wherein the pressure wave generator comprises an Activator within the oil field, the Activator being configured to apply pressure waves within the oil field.

15. The system of claim 9, wherein the pressure wave generator comprises an Activator outside of the oil field, the Activator being configured to apply pressure waves outside of the oil field.

16. The system of claim 9, wherein the pressure wave generator comprises a rotor situated in a housing pervaded by the colloidal hydrocarbonic medium.
